(19) United States
(12) Patent Application Publication
(10) Pub. No.: US 2003/0177419 A1
(43) Pub. Date: Sep. 18, 2003

(54) Facilitating the debugging of applications by employing user defined or redefined symbols

(75) Inventors: Barry M. Baker, Fishkill, NY (US); Daniel S. Gritter, Poughkeepsie, NY (US); Colette A. Manoni, Brewster, NY (US); Gerald B. Strait, Salt Point, NY (US); Yuk S. Tam, Astoria, NY (US); Mei-Hui Wang, Brookfield, CT (US); Joshua B. Wisniewski, Elizaville, NY (US)

Correspondence Address: Blanche E. Schiller, Esq., Heslin Rothenberg Farley & Mesiti P.C., 5 Columbia circle, Albany, NY, 12203, US

(73) Assignee: International Business Machines Corporation, Armonk, NY

(21) Appl. No.: 10/099,286

(22) Filed: Mar. 15, 2002

(51) Int. Cl. H02H 3/05

(52) U.S. Cl. 714/48

(57) ABSTRACT

Debugging of an application is facilitated by employing user defined and/or redefined symbols in the debugging. User defined symbols correspond to terms that are not referenced in the application. A user defined function of the user defined symbol is used to obtain the location of the term corresponding to the symbol. User defined symbols or compiler generated symbols may be redefined.

### CROSS-REFERENCE TO RELATED APPLICATIONS

This application contains subject matter which is related to the subject matter of the following applications, each of which is assigned to the same assignee as this application and filed on the same day as this application. Each of the below listed applications is hereby incorporated herein by reference in its entirety:

“Facilitating The Use Of Aliases During The Debugging Of Applications,” Baker et al., Ser. No. ______, (IBM Docket No. POU920010138US1), filed herewith; and

“Generating A Common Symbol Table For Symbols Of Independent Applications,” Baker et al., Ser. No. ______, (IBM Docket No. POU920010137US1), filed herewith.

### TECHNICAL FIELD

This invention relates, in general, to the debugging of computer applications, and in particular, to facilitating the debugging of computer applications by employing user defined and/or redefined symbols in the debugging.

### BACKGROUND OF THE INVENTION

Computer applications (or programs) are created using programming languages. These programming languages include human-readable text, which is translated by a compiler to generate machine-readable instructions. In particular, the compiler translates each line of the programming language into machine-readable instructions, which perform the logical task described by the line of programming language code.

During the course of programming, errors may occur due to programmer error. These errors include either syntax errors or logic errors. Syntax errors are caught by the compiler, which refuses to generate machine instructions for a line of programming language that it does not understand. Logic errors are caught by detecting that the application does not perform as expected, often resulting in program exceptions or incorrect behavior. While syntax errors can be corrected by determining the correct syntax, logic errors are often much more difficult to ascertain. For this reason, a special class of computer programs has been developed. These programs are called debuggers. One example of a debugger is described in U.S. Pat. No. 4,636,940, entitled “Logic Analyzer Using Source Programs Or Other User Defined Symbols In The Trace Specification And The Trace Listing,” issued Jan. 13, 1987, which is hereby incorporated herein by reference in its entirety. A debugger allows the user to trace through the user's own application, while it is executing on the computer, to determine the instance or instances where the logical flow of the application is incorrectly designed.

A debugger uses debugging information to debug, at runtime, the state of variables of the application. The debugging information includes symbols that describe how the variables of the application are stored and what fields the variables contain. Examples of techniques to generate debugging information are described in U.S. Pat. No. 5,715,460 entitled “Template Based Facility For Formatting Compiler Output,” issued Feb. 3, 1998; and U.S. Pat. No. 5,560,009, entitled “Generating Symbolic Debug Information by Merging Translation and Compiler Debug Information,” issued Sep. 24, 1996, each of which is hereby incorporated herein by reference in its entirety.

The debugging information is generated by the compiler, and thus, includes compiler generated symbols. However, at times, compiler generated symbols are inadequate for debugging an application.

Therefore, a need exists for a capability that enables the provision of user defined symbols, and the evaluation of such symbols. A further need exists for a capability that enables compiler generated or user defined symbols to be redefined.

### SUMMARY OF THE INVENTION

The shortcomings of the prior art are overcome and additional advantages are provided through the provision of a method of facilitating debugging of applications. The method includes, for instance, obtaining a symbol to be used in debugging an application, the symbol corresponding to a term unreferenced in the application; and using the symbol in debugging the application.

In a further aspect of the present invention, a method of facilitating debugging of applications is provided. The method includes, for instance, determining whether a symbol to be used in debugging an application is included in an override symbol table; using the override symbol table to obtain information usable in debugging the application, in response to the determining indicating the symbol is included in the override symbol table; inquiring whether the symbol is included in a program symbol table, in response to the determining indicating that the symbol is not included in the override symbol table; using the program symbol table to obtain information usable in debugging the application, in response to the inquiry indicating the symbol is included in the program symbol table; checking whether the symbol is included in a user defined symbol table, in response to the inquiry indicating the symbol is not included in the program symbol table; and using the user defined symbol table to obtain information usable in debugging the application, in response to the checking indicating the symbol is included in the user defined symbol table.

In yet a further aspect of the present invention, a method of facilitating debugging of applications is provided. The method includes, for instance, identifying a symbol to be used in debugging an application, the symbol having a definition; and redefining the symbol, wherein the redefined symbol is used in debugging the application.

System and computer program products corresponding to the above-summarized methods are also described and claimed herein.

Advantageously, a capability is provided that enables user defined symbols to be employed in debugging an application. In one aspect, the capability enables user defined symbols to be provided and to be resolved by techniques provided by the user. This allows users to view areas within the application, such as system data areas, that are not defined or referenced in the application.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1a depicts one embodiment of a computing environment incorporating and using one or more aspects of the present invention;

FIG. 1b depicts one embodiment of a distributed debugger executing within the computing environment of FIG. 1a, in accordance with an aspect of the present invention;

FIG. 2 depicts one example of a user defined symbol table used in debugging an application, in accordance with an aspect of the present invention;

FIG. 3 depicts one embodiment of the logic associated with using the user defined symbol table of FIG. 2 in the debugging of an application, in accordance with an aspect of the present invention;

FIG. 4 depicts one example of an override symbol table used in debugging an application, in accordance with an aspect of the present invention; and

FIG. 5 depicts one embodiment of the logic associated with using the override symbol table of FIG. 4 in the debugging of an application, in accordance with an aspect of the present invention.

### BEST MODE FOR CARRYING OUT THE INVENTION

In one aspect of the present invention, a capability is provided for facilitating the debugging of an application by enabling user defined symbols to be used in debugging the application. The user defined symbols correspond to terms (e.g., strings employed by a user to represent items, areas, etc. to be debugged) that are undefined or unreferenced in the application being debugged. For example, user defined symbols are used to view system data areas that are not defined or referenced in the application. (The words referenced/unreferenced will be used hereinafter, and are to encompass the words defined/undefined, respectively.)

A user defined symbol is similar to a compiler generated symbol in that both include information usable in debugging. For instance, both include a symbol name and return type characteristics of the symbol. Further, both include information usable in locating the term to be debugged, which corresponds to the symbol. However, in the case of a compiler generated symbol, the symbol includes the address or list of addresses for the term, as generated by the compiler; and in the case of a user defined symbol, the symbol includes an indication of a resolve function defined by the user to be used to determine the address or addresses of the term. Thus, the compiler generated information of a compiler generated symbol includes location information, and user defined information of a user defined symbol includes a function to be used in identifying the location.

In a further aspect of the present invention, symbols are redefined, and the redefined symbols are used in debugging an application. The redefining of a symbol includes overriding information associated with the symbol. For instance, for a compiler generated symbol, compiler generated information of the symbol is overridden. Similarly, for a user defined symbol, user defined information of the symbol is overridden.

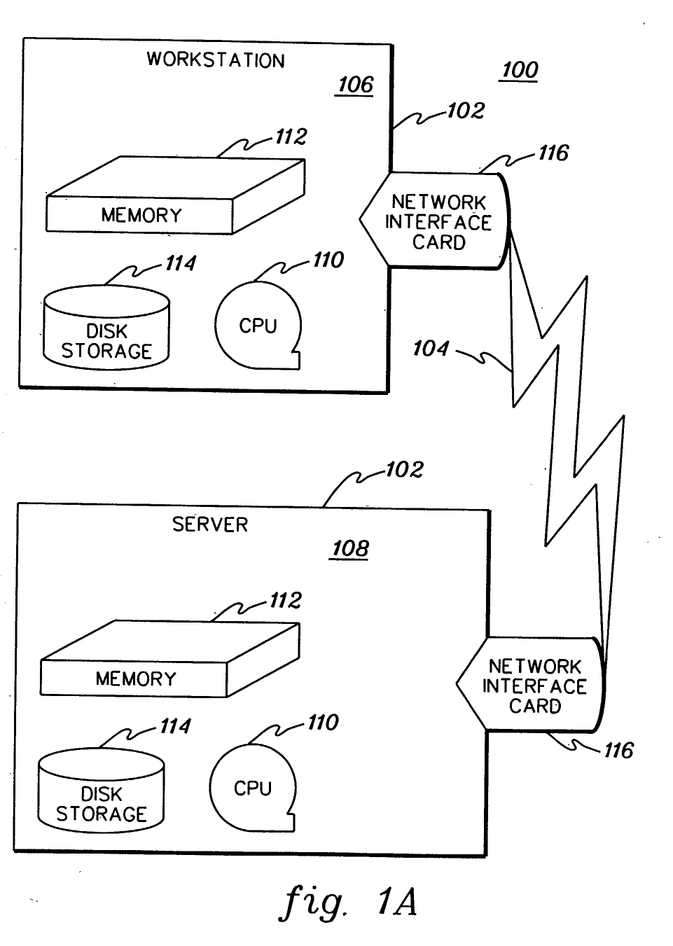

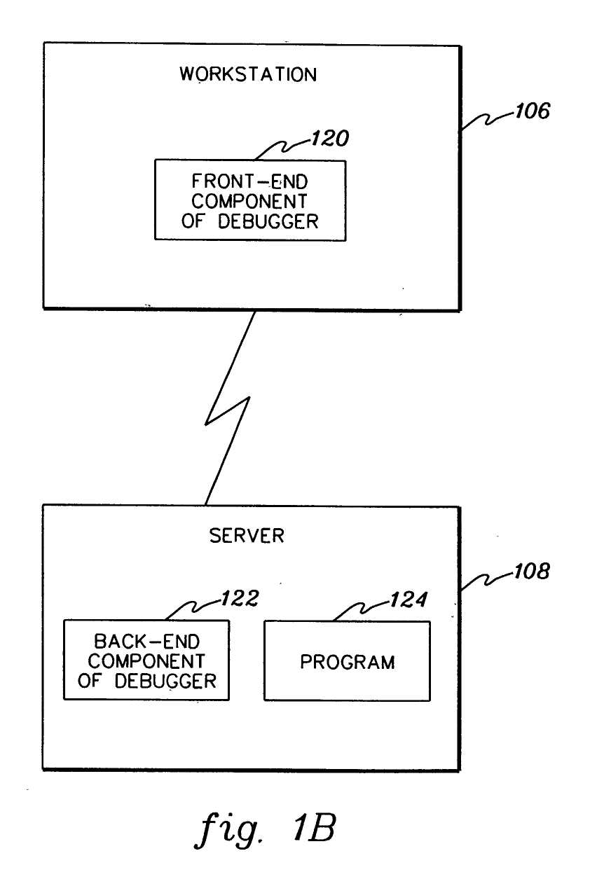

One embodiment of a computing environment incorporating and using one or more aspects of the present invention is depicted in FIG. 1a. A computing environment 100 includes, for instance, a plurality of computing units 102 coupled to one another via a connection 104. In one example, one of the computing units is a workstation 106 executing an operating system, such as Windows NT or LINUX, as examples, and the other computing unit is a server 108 executing the z/OS or OS/390 operating system offered by International Business Machines Corporation, Armonk, N.Y. Each computing unit includes, for example, a central processing unit (CPU) 110, memory 112, and one or more input/output devices 114, which are well known in the art.

Connection 104 is, for instance, a TCP/IP connection, which includes a network interface card 116 at each end. In other embodiments, however, connection 104 may be any type of connection, such as a wire connection, token ring or network connection, to name just a few examples.

The computing environment described above is only one example. One or more aspects of the present invention can be incorporated and used with other types of computing units, computers, processors, nodes, systems, workstations and/or other environments, without departing from the spirit of the present invention.

For example, aspects of the present invention can be used in a single system environment. One such environment may include, for instance, an RS/6000 computer system running the AIX operating system offered by International Business Machines Corporation, Armonk, N.Y. In yet a further embodiment, one or more aspects of the invention can be included in a large parallel system with a plurality of units coupled to one another. These and many other types of environments are capable of incorporating and using aspects of the present invention.

In one embodiment, executing within the computing environment is a debugger. As one example, this debugger is a distributed debugger, in which components of the debugger are run on the various computing units. For example, as shown in FIG. 1b, a front-end component 120 of a debugger is executing on workstation 106 and a back-end component 122 of the debugger is executing on server 108. The front-end component includes a user interface to facilitate user input to the debugger; and the back-end component includes the logic used in performing the debugging of a user's program 124 running on server 108. One example of such a distributed debugger is the IBM distributed debugger.

Although a distributed debugger is described herein, the capabilities of the present invention are not limited to such a debugger. Non-distributed debuggers may also be used. For example, one or more aspects of the present invention can be incorporated and used in a single system environment using a non-distributed debugger.

A debugger is used during application development to detect one or more errors within the application. In one example, a user provides to the debugger an expression of one or more terms to be debugged. The expression is parsed into tokens, and information regarding the tokens is obtained. This information is then used in debugging the expression. Although tokens may include operators (e.g., +, −, =, <, >, etc.), the processing described herein pertains to tokens other than operators, since the information being obtained is not necessary for operators. However, in other embodiments, similar processing for operators may be performed.

When the tokens correspond to terms referenced in the application, the information includes compiler generated debug information. The compiler generated debug information includes symbols generated by the compiler for the referenced terms, and at least a portion of the compiler generated debug information is stored in a symbol table, referred to as a program symbol table.

At times, however, it is desirous to obtain information for terms that are not referenced in the application. Thus, in accordance with an aspect of the present invention, when the tokens correspond to terms not referenced in the application, the information includes user defined information. The user defined information includes user defined symbols created by one or more users in order to obtain information for those terms not referenced in the application. In one embodiment, the user defined symbols are available to all (or a subset of) debugger users, and are resolved by user defined functions. User defined symbols do not depend on debug information generated by the compiler. Further, user defined symbols do not depend on the compilation or assembly of the particular program to be debugged; rather, they are a part of the compilation or assembly of a user defined symbol table (described below).

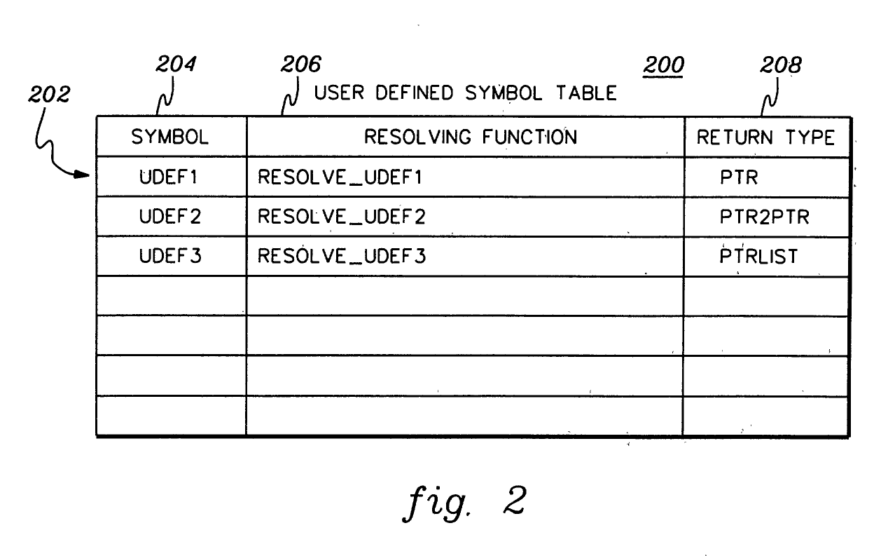

In one embodiment, the user defined symbols are stored in a user defined symbol table 200 (FIG. 2). User defined symbol table 200 includes one or more symbol entries 202, and each entry includes, for instance:

(a) A symbol field 204 identifying a user defined symbol. The symbol corresponds to an unreferenced term of the application that may be debugged (e.g., a string used to reference system data);

(b) A resolving function field 206 indicating a resolve function to be used to resolve the symbol to obtain the location of the term. In one example, the resolving function is used to map the symbol name to an area of storage. The resolving function is defined by the user, and one example of a resolving function is as follows:

resolve_globall(void){

void * result;
/* system dependent code to resolve the “globall”

symbol */

return result;

}; and

(c) A return type 208 designating the return type of the function. In one example, the return type is used to signify how the area of storage should be displayed (e.g., a pointer, a pointer to a pointer, a pointer list, etc.).

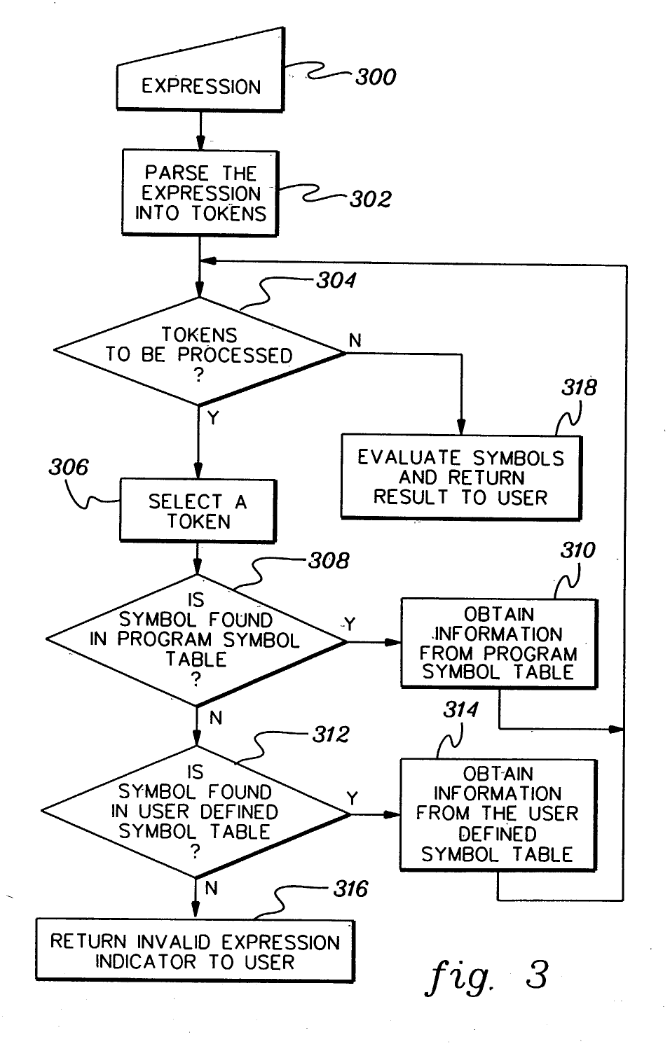

In one aspect of the present invention, the user defined symbol table is employed in debugging an application. One embodiment of the logic associated with using the user defined system table in debugging an application is described with reference to FIG. 3. As one example, the logic of FIG. 3 is performed by a debugger.

Initially, an expression having one or more terms to be debugged is obtained, STEP 300. For example, a user enters the expression into the debugger. Thereafter, the expression is parsed into one or more tokens corresponding to the one or more terms to be debugged, STEP 302. The parsing is performed, for instance, by a parser segment of the debugger that parses the expression based on rules associated with the particular program and language used to code the expression.

Subsequent to parsing the expression, or at least a portion of the expression, a determination is made as to whether there are tokens to be processed, INQUIRY 304. Should there be one or more tokens to be processed, then a token is selected, STEP 306.

Thereafter, a determination is made as to whether a symbol corresponding to the token is located in the program symbol table (i.e., the table created by the compiler), INQUIRY 308. For instance, the program symbol table is searched for a symbol name corresponding to the token. If the symbol (and thus, the token) is found in the program symbol table, then information of the symbol, usable in debugging, is obtained from the program symbol table, STEP 310. This information includes, for instance, the symbol name, a return type, and location information used to locate the term corresponding to the symbol. Subsequent to obtaining the information, processing continues with INQUIRY 304 to determine if other tokens are to be processed.

Returning to INQUIRY 308, if the symbol is not located in the program symbol table, then a further determination is made as to whether a symbol corresponding to the token is included in the user defined symbol table, INQUIRY 312. Should the symbol be located in the user defined symbol table, then information of the symbol, usable in debugging, is retrieved from the user defined symbol table. This information includes, for instance, the symbol name, return type, and a resolving function used to locate the term corresponding to the symbol, STEP 314. Thereafter, processing continues with INQUIRY 304.

Returning to INQUIRY 312, if the symbol is not found in the user defined symbol table, and thus the symbol is absent from both the program symbol table and the user defined symbol table, then an invalid expression indicator is returned to the user, STEP 316.

Returning to INQUIRY 304, subsequent to processing the tokens and obtaining information about the symbols corresponding to those tokens, the symbols are evaluated, STEP 318. In one example, during the evaluation, the locations (e.g., addresses) of the terms corresponding to the symbols are obtained. If a symbol is in the program symbol table, then information included in the symbol identifies the location of the term corresponding to that symbol. However, if the symbol is in the user defined symbol table, then the resolving function of the symbol is used to determine the location of the term corresponding to that symbol. The information stored at the identified locations is then used, as well as other information of the symbols, to evaluate the expression. The result is returned to the user.

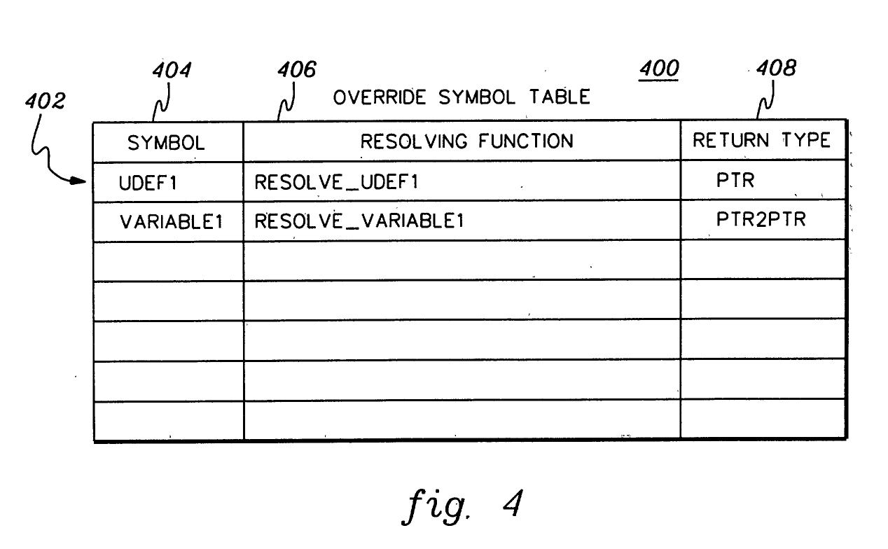

In a further aspect of the present invention, one or more compiler generated symbols and/or one or more user defined symbols are overridden during, for instance, the runtime of an application. The overriding of a symbol includes redefining information associated with that symbol. In one example, to redefine a symbol, an override symbol table is utilized. The override symbol table has, in one embodiment, the same format as the user defined symbol table. For instance, an override symbol table 400 (FIG. 4) includes one or more symbol entries 402, and each entry includes a symbol field 404 indicating the name of the symbol to be overridden; a resolving function field 406 identifying the function to be used in resolving the symbol; and a return type 408.

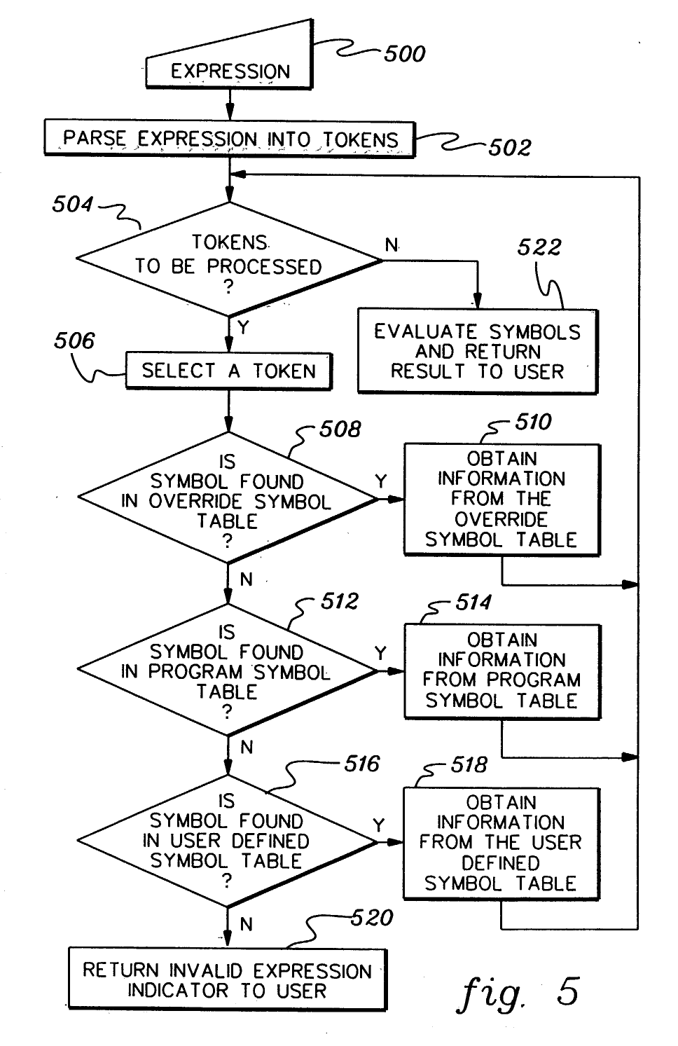

In one aspect of the present invention, the override symbol table is checked before the program symbol table or the user defined symbol table. This allows the user to override definitions of particular symbols that are either defined in the program symbol table or the user defined symbol table. One embodiment of the logic associated with using the override symbol table in debugging an application is described with reference to FIG. 5. In one example, the logic of FIG. 5 is performed by the debugger.

Referring to FIG. 5, an expression of one or more terms is obtained, STEP 500, and that expression is parsed into one or more tokens, STEP 502. Thereafter, a determination is made as to whether there are tokens to be processed, INQUIRY 504. Should there be one or more tokens to be processed, then a token is selected, STEP 506.

Subsequent to selecting a token, a determination is made as to whether a symbol corresponding to the token is included in the override symbol table, INQUIRY 508. If the symbol is located in the override symbol table, then information of the symbol, usable in debugging, is retrieved from the override symbol table, STEP 510. This information includes, for instance, the symbol name, a return type, and a resolving function used to locate the term corresponding to the symbol. Subsequently, processing continues with INQUIRY 504.

Returning to INQUIRY 508, if the symbol is not found in the override symbol table, then a further determination is made as to whether a symbol corresponding to the token is found in the program symbol table, INQUIRY 512. Should the symbol be found in the program symbol table, then information of that symbol, usable in debugging, is obtained from the program symbol table, STEP 514. This information includes, for instance, the symbol name, a return type, and location information. Processing then continues with INQUIRY 504.

However, if the symbol is not found in the program symbol table, INQUIRY 512, then a further determination is made as to whether a symbol corresponding to the token is included in the user defined symbol table, INQUIRY 516. If the symbol is found in the user defined symbol table, then information of the symbol, usable in debugging, is retrieved from the user defined symbol table, STEP 518. This information includes, for instance, the symbol name, a return type, and a resolving function used to locate the term corresponding to the symbol. Thereafter, processing continues with INQUIRY 504.

Returning to INQUIRY 516, if the symbol is not found in the override symbol table, the program symbol table, or the user defined symbol table, then an invalid expression indicator is returned to the user, STEP 520.

Returning to INQUIRY 504, if there are no more tokens to be processed, then the symbols corresponding to those tokens are evaluated, and the result is returned to the user, STEP 522. In one example, during the evaluation, the locations of the terms corresponding to the symbols are obtained. If a symbol is in the program symbol table, then information included in the symbol identifies the location of that term. However, if the symbol is in the user defined symbol table or the override symbol table, then the resolving function of the symbol is used to determine the location of the term.

Described in detail above is a capability for enabling user defined symbols to be employed in debugging applications. As one example, a symbol corresponding to an unreferenced term of an application is obtained (e.g., located, provided, created, received, have), and that symbol is used in debugging the application.

Further, in another aspect of the present invention, symbols either generated by the compiler or user defined may be redefined to provide different information regarding the symbol. The capabilities of the present invention allow a user to define symbols and provide its own functions to resolve the symbols in a debugger session prior to or after resolving the symbol from the program symbol table.

Although in the above embodiments, a user defined table and an override symbol table are used, this is only one example. In another example, one symbol table defined by the user may be provided that satisfies both functions. For example, if the user defined symbol table is searched prior to the program symbol table, it allows users to redefine a symbol (i.e., override the information generated by the compiler).

Although the embodiments herein refer to a compiler, aspects of the invention are equally applicable to an assembler environment or other like environments. Thus, the term compiler includes degenerate forms of compilers, such as assemblers and other like components.

Moreover, although the term table is utilized herein, the structures used to hold the information are not limited to table structures. Many types of data structures are usable, and thus, the term table includes those structures.

Yet further, the term user as employed herein includes system administrators and the like.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating debugging of applications, said method comprising:
obtaining a symbol to be used in debugging an application, the symbol corresponding to a term unreferenced in the application; and
using the symbol in debugging the application.

2. The method of claim 1, wherein the symbol is located in a user defined symbol table.

3. The method of claim 2, wherein the obtaining comprises:
receiving an expression from a user to debug the application;
parsing the expression into one or more tokens, at least one token corresponding to the term; and
using the at least one token to obtain the symbol in the user defined symbol table.

4. The method of claim 2, wherein the user defined symbol table is accessible to a plurality of users.

5. The method of claim 1, wherein said symbol comprises return type information usable in debugging the application.

6. The method of claim 1, wherein said symbol comprises an indication of a resolve function to be used to provide an address of the term.

7. The method of claim 1, wherein the obtaining comprises:
checking whether the symbol is included in a program symbol table; and
locating the symbol in a user defined symbol table, in response to the checking indicating the symbol is not included in the program symbol table.

8. The method of claim 7, wherein the using comprises employing information of the symbol of the user defined symbol table to debug the application.

9. The method of claim 1, wherein the obtaining comprises:
determining whether the symbol is included in an override symbol table; and
locating the symbol in the override symbol table, in response to the determining indicating the symbol is included in the override symbol table.

10. The method of claim 9, wherein the using comprises employing information of the symbol of the override symbol table to debug the application.

11. The method of claim 9, wherein information of the symbol is redefined by the override symbol table.

12. The method of claim 9, further comprising locating the symbol in a user defined symbol table, in response to the determining indicating the symbol is not included in the override symbol table.

13. The method of claim 12, wherein the using comprises employing information of the symbol of the user defined symbol table to debug the application.

14. The method of claim 1, wherein the using comprises employing a resolve function of the symbol to locate the term.

15. The method of claim 1, further comprising defining the symbol to be used.

16. The method of claim 15, wherein the defining is performed by a user.

17. The method of claim 15, wherein the defining includes providing a resolve function for the symbol, the resolve function usable in determining an address of the term.

18. A method of facilitating debugging of applications, said method comprising:
determining whether a symbol to be used in debugging an application is included in an override symbol table;
using the override symbol table to obtain information usable in debugging the application, in response to the determining indicating the symbol is included in the override symbol table;
inquiring whether the symbol is included in a program symbol table, in response to the determining indicating that the symbol is not included in the override symbol table;
using the program symbol table to obtain information usable in debugging the application, in response to the inquiry indicating the symbol is included in the program symbol table;
checking whether the symbol is included in a user defined symbol table, in response to the inquiry indicating the symbol is not included in the program symbol table; and
using the user defined symbol table to obtain information usable in debugging the application, in response to the checking indicating the symbol is included in the user defined symbol table.

19. The method of claim 18, wherein the symbol corresponds to a term of the application to be debugged, and the using the override symbol table includes employing a resolve function of the symbol of the override symbol table to locate the term.

20. The method of claim 18, wherein the symbol corresponds to a term of the application to be debugged, and the using the program symbol table includes employing compiler generated information of the symbol of the program symbol table to locate the term.

21. The method of claim 18, wherein the symbol corresponds to a term of the application to be debugged, and the using the user defined symbol table includes employing a resolve function of the symbol of the user defined symbol table to locate the term.

22. A method of facilitating debugging of applications, said method comprising:
identifying a symbol to be used in debugging an application, the symbol having a definition; and
redefining the symbol, wherein the redefined symbol is used in debugging the application.

23. The method of claim 22, wherein the redefining comprises overriding compiler generated information of the symbol with user defined information usable in debugging the application.

24. The method of claim 22, wherein the redefining comprising overriding user defined information of the symbol with revised user defined information usable in debugging.

25. The method of claim 24, wherein the revised user defined information includes a resolving function.

26. The method of claim 22, wherein the redefining is performed during runtime of the application.

27. The method of claim 22, wherein the redefining is dependent on whether the symbol is a compiler generated symbol or a user defined symbol.

28. A system of facilitating debugging of applications, said system comprising:
means for obtaining a symbol to be used in debugging an application, the symbol corresponding to a term unreferenced in the application; and
means for using the symbol in debugging the application.

29. The system of claim 28, wherein the symbol is located in a user defined symbol table.

30. The system of claim 29, wherein the means for obtaining comprises:
means for receiving an expression from a user to debug the application;
means for parsing the expression into one or more tokens, at least one token corresponding to the term; and
means for using the at least one token to obtain the symbol in the user defined symbol table.

31. The system of claim 29, wherein the user defined symbol table is accessible to a plurality of users.

32. The system of claim 28, wherein said symbol comprises return type information usable in debugging the application.

33. The system of claim 28, wherein said symbol comprises an indication of a resolve function to be used to provide an address of the term.

34. The system of claim 28, wherein the means for obtaining comprises:
means for checking whether the symbol is included in a program symbol table; and
means for locating the symbol in a user defined symbol table, in response to the checking indicating the symbol is not included in the program symbol table.

35. The system of claim 34, wherein the means for using comprises means for employing information of the symbol of the user defined symbol table to debug the application.

36. The system of claim 28, wherein the means for obtaining comprises:
means for determining whether the symbol is included in an override symbol table; and
means for locating the symbol in the override symbol table, in response to the determining indicating the symbol is included in the override symbol table.

37. The system of claim 36, wherein the means for using comprises means for employing information of the symbol of the override symbol table to debug the application.

38. The system of claim 36, wherein information of the symbol is redefined by the override symbol table.

39. The system of claim 36, further comprising means for locating the symbol in a user defined symbol table, in response to the determining indicating the symbol is not included in the override symbol table.

40. The system of claim 39, wherein the means for using comprises means for employing information of the symbol of the user defined symbol table to debug the application.

41. The system of claim 28, wherein the means for using comprises means for employing a resolve function of the symbol to locate the term.

42. The system of claim 28, further comprising means for defining the symbol to be used.

43. The system of claim 42, wherein the means for defining comprises one or more user definitions.

44. The system of claim 42, wherein the means for defining includes means for providing a resolve function for the symbol, the resolve function usable in determining an address of the term.

45. A system of facilitating debugging of applications, said system comprising:
means for determining whether a symbol to be used in debugging an application is included in an override symbol table;
means for using, in response to the means for determining indicating the symbol is included in the override symbol table, the override symbol table to obtain information usable in debugging the application;
means for inquiring, in response to the means for determining indicating that the symbol is not included in the override symbol table, whether the symbol is included in a program symbol table;
means for using, in response to the means for inquiring indicating the symbol is included in the program symbol table, the program symbol table to obtain information usable in debugging the application;
means for checking, in response to the means for inquiring indicating the symbol is not included in the program symbol table, whether the symbol is included in a user defined symbol table; and
means for using, in response to the means for checking indicating the symbol is included in the user defined symbol table, the user defined symbol table to obtain information usable in debugging the application.

46. The system of claim 45, wherein the symbol corresponds to a term of the application to be debugged, and the means for using the override symbol table includes means for employing a resolve function of the symbol of the override symbol table to locate the term.

47. The system of claim 45, wherein the symbol corresponds to a term of the application to be debugged, and the means for using the program symbol table includes means for employing compiler generated information of the symbol of the program symbol table to locate the term.

48. The system of claim 45, wherein the symbol corresponds to a term of the application to be debugged, and the means for using the user defined symbol table includes means for employing a resolve function of the symbol of the user defined symbol table to locate the term.

49. A system of facilitating debugging of applications, said system comprising:
means for identifying a symbol to be used in debugging an application, the symbol having a definition; and
means for redefining the symbol, wherein the redefined symbol is used in debugging the application.

50. The system of claim 49, wherein the means for redefining comprises means for overriding compiler generated information of the symbol with user defined information usable in debugging the application.

51. The system of claim 49, wherein the means for redefining comprising means for overriding user defined information of the symbol with revised user defined information usable in debugging.

52. The system of claim 51, wherein the revised user defined information includes a resolving function.

53. The system of claim 49, wherein the redefining is performed during runtime of the application.

54. The system of claim 49, wherein the redefining is dependent on whether the symbol is a compiler generated symbol or a user defined symbol.

55. A system of facilitating debugging of applications, said system comprising:
a symbol to be used in debugging an application, the symbol corresponding to a term unreferenced in the application; and
a debugger to use the symbol in debugging the application.

56. A system of facilitating debugging of applications, said system comprising:
a debugger to:
determine whether a symbol to be used in debugging an application is included in an override symbol table;
use the override symbol table to obtain information usable in debugging the application, in response to the determining indicating the symbol is included in the override symbol table;
inquire whether the symbol is included in a program symbol table, in response to the determining indicating that the symbol is not included in the override symbol table;
use the program symbol table to obtain information usable in debugging the application, in response to the inquiry indicating the symbol is included in the program symbol table;
check whether the symbol is included in a user defined symbol table, in response to the inquiry indicating the symbol is not included in the program symbol table; and
use the user defined symbol table to obtain information usable in debugging the application, in response to the checking indicating the symbol is included in the user defined symbol table.

57. A system of facilitating debugging of applications, said system comprising:
a symbol to be used in debugging an application, the symbol having a definition; and
a debugger to redefine the symbol, wherein the redefined symbol is used in debugging the application.

58. At least one program storage device readable by a machine tangibly embodying at least one program of instructions executable by the machine to perform a method of facilitating debugging of applications, said method comprising:
obtaining a symbol to be used in debugging an application, the symbol corresponding to a term unreferenced in the application; and
using the symbol in debugging the application.

59. The at least one program storage device of claim 58, wherein the symbol is located in a user defined symbol table.

60. The at least one program storage device of claim 59, wherein the obtaining comprises:
receiving an expression from a user to debug the application;
parsing the expression into one or more tokens, at least one token corresponding to the term; and
using the at least one token to obtain the symbol in the user defined symbol table.

61. The at least one program storage device of claim 59, wherein the user defined symbol table is accessible to a plurality of users.

62. The at least one program storage device of claim 58, wherein said symbol comprises return type information usable in debugging the application.

63. The at least one program storage device of claim 58, wherein said symbol comprises an indication of a resolve function to be used to provide an address of the term.

64. The at least one program storage device of claim 58, wherein the obtaining comprises:
checking whether the symbol is included in a program symbol table; and
locating the symbol in a user defined symbol table, in response to the checking indicating the symbol is not included in the program symbol table.

65. The at least one program storage device of claim 64, wherein the using comprises employing information of the symbol of the user defined symbol table to debug the application.

66. The at least one program storage device of claim 58, wherein the obtaining comprises:
determining whether the symbol is included in an override symbol table; and
locating the symbol in the override symbol table, in response to the determining indicating the symbol is included in the override symbol table.

67. The at least one program storage device of claim 66, wherein the using comprises employing information of the symbol of the override symbol table to debug the application.

68. The at least one program storage device of claim 66, wherein information of the symbol is redefined by the override symbol table.

69. The at least one program storage device of claim 66, wherein said method further comprises locating the symbol in a user defined symbol table, in response to the determining indicating the symbol is not included in the override symbol table.

70. The at least one program storage device of claim 69, wherein the using comprises employing information of the symbol of the user defined symbol table to debug the application.

71. The at least one program storage device of claim 58, wherein the using comprises employing a resolve function of the symbol to locate the term.

72. The at least one program storage device of claim 58, wherein said method further comprises defining the symbol to be used.

73. The at least one program storage device of claim 72, wherein the defining is based on user input.

74. The at least one program storage device of claim 72, wherein the defining includes providing a resolve function for the symbol, the resolve function usable in determining an address of the term.

75. At least one program storage device readable by a machine tangibly embodying at least one program of instructions executable by the machine to perform a method of facilitating debugging of applications, said method comprising:
determining whether a symbol to be used in debugging an application is included in an override symbol table;
using the override symbol table to obtain information usable in debugging the application, in response to the determining indicating the symbol is included in the override symbol table;
inquiring whether the symbol is included in a program symbol table, in response to the determining indicating that the symbol is not included in the override symbol table;
using the program symbol table to obtain information usable in debugging the application, in response to the inquiry indicating the symbol is included in the program symbol table;
checking whether the symbol is included in a user defined symbol table, in response to the inquiry indicating the symbol is not included in the program symbol table; and
using the user defined symbol table to obtain information usable in debugging the application, in response to the checking indicating the symbol is included in the user defined symbol table.

76. The at least one program storage device of claim 75, wherein the symbol corresponds to a term of the application to be debugged, and the using the override symbol table includes employing a resolve function of the symbol of the override symbol table to locate the term.

77. The at least one program storage device of claim 75, wherein the symbol corresponds to a term of the application to be debugged, and the using the program symbol table includes employing compiler generated information of the symbol of the program symbol table to locate the term.

78. The at least one program storage device of claim 75, wherein the symbol corresponds to a term of the application to be debugged, and the using the user defined symbol table includes employing a resolve function of the symbol of the user defined symbol table to locate the term.

79. At least one program storage device readable by a machine tangibly embodying at least one program of instructions executable by the machine to perform a method of facilitating debugging of applications, said method comprising:
identifying a symbol to be used in debugging an application, the symbol having a definition; and
redefining the symbol, wherein the redefined symbol is used in debugging the application.

80. The at least one program storage device of claim 79, wherein the redefining comprises overriding compiler generated information of the symbol with user defined information usable in debugging the application.

81. The at least one program storage device of claim 79, wherein the redefining comprising overriding user defined information of the symbol with revised user defined information usable in debugging.

82. The at least one program storage device of claim 81, wherein the revised user defined information includes a resolving function.

83. The at least one program storage device of claim 79, wherein the redefining is performed during runtime of the application.

84. The at least one program storage device of claim 79, wherein the redefining is dependent on whether the symbol is a compiler generated symbol or a user defined symbol.
